(19) United States
(12) Patent Application Publication
(10) Pub. No.: US 2008/0251555 A1
(43) Pub. Date: Oct. 16, 2008

(54) CARBON FIBER ACCESSORY MOUNTING BRACKET

(76) Inventor: Mark A. Andrews, Middleton, WI (US)

Correspondence Address: BOYLE FREDRICKSON S.C., 840 North Plankinton Avenue, MILWAUKEE, WI, 53203, US

(21) Appl. No.: 11/735,837

(22) Filed: Apr. 16, 2007

(51) Int. Cl. B62J 11/00

(52) U.S. Cl. 224/427

(57) ABSTRACT

An aerodynamic accessory mounting bracket includes a body formed from a carbon fiber material. The body includes a first portion constructed to engage a seat post of a bicycle and a second portion that extends rearward from the first portion. The second portion of the body is constructed to support the connection of accessories such as water bottles, spare tires, CO₂ containers, tire pumps or other cycling accessories thereto. The aerodynamic construction of the mounting bracket reduces the drag effects associated with the accessory mounting system.

### BACKGROUND OF THE INVENTION

The present invention relates to bicycle accessory mounting systems and, more particularly, to a carbon fiber bodied accessory mounting bracket.

Several different forces oppose the movement of a bicycle in use. A major force acting against the movement of the bicycle is the drag induced by the bicycle's movement through the air. Although this force is not particularly problematic for recreational riders, the drag forces are problematic to athletic or other professional riders. The faster the movement of a bicycle, the greater the drag force becomes. Greater drag requires the rider to expend greater energy to overcome the drag and detrimentally affects timed rider performance. Accordingly, reducing the drag forces is an important consideration in competitive cycling.

A major source of drag on a bicycle results from the flow of air over and around the entirety of the bicycle assembly. Although the frame of a bicycle can be constructed to substantially minimize the negative effects of drag, each component attached to the bicycle frame alters the aerodynamic performance of the bicycle. Dramatic changes in the contour of the bicycle and components connected thereto can introduce increased levels of undesirable drag. One such system is the accessory mounting system. Commonly, athletic and competitive riders participate in races or rides of extended duration as a test of endurance and stamina. These rides generally require the cyclist to carry several accessories to better the odds of ride completion. Such accessories can include spare tires, tire filling devices such as pumps or CO₂ bottles, rain gear, multi-function tools, and one or more fluid containers or water bottles. The devices are merely exemplary and a rider may attach anything to the bicycle that they believe may be required during a ride to maintain either of the bicycle or the rider.

Although being configured to support multiple cycling accessories, many known accessory mounting systems do not adequately address the aerodynamic impact of the mounting system and suffer from other drawbacks as well. Commonly, a number of interconnecting links are fastened together about a portion of a frame of a bicycle. A number of fasteners secure the relative location of each of the links. The interconnecting links and associated fasteners present the potential for marring the finish of the frame, require extensive assembly time, and are frequently less than aesthetically pleasing. Additionally, the use of multiple fasteners presents the potential for the fasteners coming loose during bicycle operation. That is, shocks and vibrations generated during a ride can loosen the fasteners which results in an obnoxious rattle and/or lose of the desired accessories. Additionally, these same vibrations can result in premature failure of any one of the interconnecting links.

Accordingly, a need exists for a bicycle accessory mounting system with improved aerodynamic performance and simplified installation. It is further desired to provide an accessory mounting system that is constructed to withstand the rigors of aggressive use.

### BRIEF DESCRIPTION OF THE INVENTION

The present invention provides an accessory mounting system and method of forming an accessory mounting bracket that overcomes one or more of the aforementioned drawbacks.

An aerodynamic accessory mounting bracket according to one aspect of the invention includes a body formed from a carbon fiber material. The body includes a first portion constructed to engage a seat post of a bicycle and a second portion that extends rearward from the first portion. The second portion of the body is constructed to support the connection of accessories such as water bottles, spare tires, CO₂ containers, tire pumps or other cycling accessories thereto. The aerodynamic construction of the mounting bracket provides an accessory mounting bracket that has a limited effect on the aerodynamic performance of the accessory mounting system.

Another aspect of the invention includes a bicycle accessory mounting bracket having a body formed of a carbon fiber material. A first portion of the body is constructed to secure the body to a seat post of a bicycle. A second portion of the body extends from the first portion and is constructed to connect an accessory to the body. The aerodynamic construction of the mounting bracket reduces the detrimental impact of the accessory mounting bracket on the aerodynamic performance of the bicycle so equipped.

A bicycle accessory mounting system according to another aspect of the invention includes a carbon fiber bracket that has a first part and a second part. The first part has a contour that substantially matches a contour of a bicycle seat post. The second part has a generally planar contour and is constructed to extend rearward of the bicycle seat post from the first part. The mounting system includes means for connecting an accessory to the second part of the bracket. The accessory mounting system provides a convenient and aerodynamic system for mounting a number of cycling accessories to a bicycle A method of forming an accessory mounting bracket according to a further aspect of the invention includes forming a body from a carbon fiber material. A passage is formed with the body and is configured to receive a portion of a bicycle frame. The method provides a convenient and economical system for producing a variety of aerodynamic accessory mounting brackets that can be quickly and simply connected to a bicycle.

Various other features, aspects, and advantages of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications. These and various other features and advantages of the present invention will be made apparent from the following detailed description and the drawings.

### BRIEF DESCRIPTION OF THE DRAWINGS

The drawings illustrate one preferred embodiment presently contemplated for carrying out the invention.

In the drawings:

FIG. 1 is an elevational view of a bicycle equipped with an accessory mounting system according to the present invention.

FIG. 2 is a perspective view of the accessory mounting system shown in FIG. 1 removed from a bicycle.

### DETAILED DESCRIPTION OF THE PREFERRED EMBODIMENT

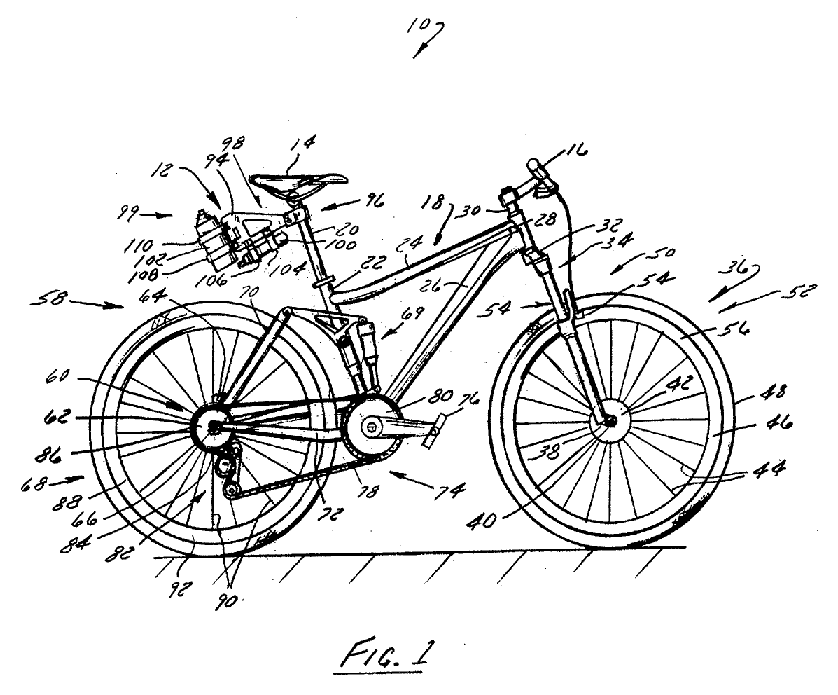

FIG. 1 shows a bicycle 10 having an accessory mounting system 12 according to the present invention. Bicycle 10 includes a seat 14 and handlebars 16 that are attached to a frame assembly 18. A seat post 20 is connected to seat 14 and slidably engages a seat tube 22 of frame assembly 18. A top tube 24 and a down tube 26 extend forwardly from seat tube 22 to a head tube 28 of frame assembly 18. Handlebars 16 are connected to a stem 30 that passes through head tube 28 and engages a fork crown 32. A pair of forks 34 extend from generally opposite ends of fork crown 32 and are constructed to support a front wheel assembly 36 at an end of each fork or a fork tip 38. Fork tips 38 engage generally opposite sides of an axle 40 that is constructed to engage a hub 42 of front wheel assembly 36. A number of spokes 44 extend from hub 42 to a rim 46 of front wheel assembly 36. A tire 48 is engaged with rim 46 such that rotation of tire 48, relative to forks 34, rotates rim 46 and hub 42.

Bicycle 10 includes a front brake assembly 50 having an actuator 52 attached to handlebars 16 and a pair of brake pads 54 positioned on generally opposite sides of front wheel assembly 36. Brake pads 54 are constructed to engage a brake wall 56 of rim 46 thereby providing a stopping or slowing force to front wheel assembly 36. A rear wheel assembly 58 includes a disc brake assembly 60 having a rotor 62 and a caliper 64 that are positioned proximate a rear axle 66. A rear wheel 68 is positioned generally concentrically about rear axle 66. Understandably, front wheel assembly 36 and rear wheel assembly 58 could be equipped with a brake assembly generally similar to front brake assembly 50 or disc brake assembly 60.

A rear wheel suspension system 69 is pivotably connected to frame assembly 18 to allow rear wheel 68 to move independent of seat 14 and handlebars 16. Suspension system 69 includes a seat stay 70 and a chain stay 72 that offset rear axle 66 from a crankset 74. Crankset 74 includes a pedal 76 that is operationally connected to a chain 78 via a chain ring or sprocket 80. Rotation of chain 78 communicates a drive force to a rear section 82 of bicycle 10. A gear cluster 84 is positioned at rear section 82 and engaged by chain 78. Gear cluster 84 is generally concentrically orientated with respect to rear axle 66 and includes a number of variable diameter gears. Gear cluster 84 is operationally connected to a hub 86 of a rear wheel 88 of rear wheel assembly 58. A number of spokes 90 extend radially between hub 86 and a rim 92 of rear wheel 88. As is commonly understood, rider operation of pedals 76 drives chain 78 thereby driving rear wheel 88 which in turn propels bicycle 10.

Understandably, bicycle 10 is shown as what is commonly understood as an off-road or mountain bike. The construction of bicycle 10 is merely exemplary. It is appreciated that the present invention is equally applicable to other bicycle constructions such as road bikes or the like. Such bikes frequently lack a front or rear wheel suspension system disposed between the connection of the wheels and the frame of the bicycle. Understandably, regardless or the terrain intended to be traversed by the bicycle, many riders desire to carry various accessories with them during a ride. Accordingly, accessory mounting system 12 is configured to allow a rider to connect a number of accessories to the bicycle 10.

Accessory mounting system 12 includes an accessory bracket or a body 94 that has a first portion 96 constructed to engage seat post 20 and a second portion 98 extending rearwardly therefrom. Body 94 is constructed of a carbon fiber material and may be formed from a unitary layer or a number of interconnected layers. It is further envisioned that when body 94 is formed from a number of interconnected layers, that the orientation of the respective carbon fibers between adjacent layers extend in generally crossing directions thereby enhancing the strength performance of body 94.

A number of accessories 99 such as a pump, tire, rain gear, a gas source 100 or a fluid container, such as a water bottle 102, are secured to body 94 via a number of respective connecting means 104, 106, 108, 110. Understandably, connecting means 104, 106, 108, 110 could be provided in any of a number of modalities including metal or plastic clamps, straps, snaps, mechanical fasteners such as screws or bolts, or hook and loop type fasteners.

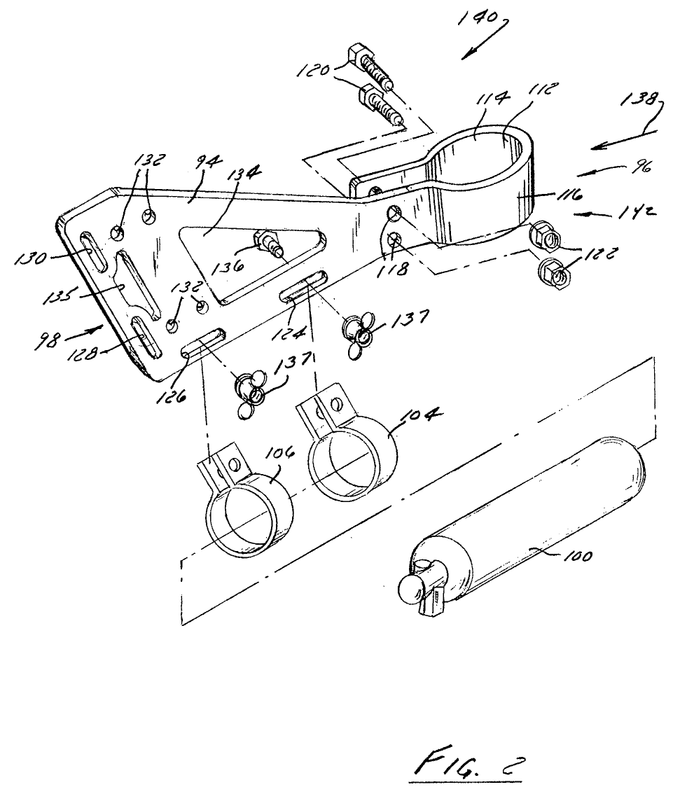

As shown in FIG. 2, first portion 96 of body 94 includes an interior contour 112 that is constructed to generally match a contour of a respective seat post 20 or seat tube 22. Body 94 is formed from a unitary sheet of carbon fiber such that first portion 96 includes a first section 114 that is constructed to generally overlying a second section 116 of first portion 96. First section 114 and second section 116 of body 94 include a number of holes 118 that are oriented such that the holes 118 formed in the first section 114 generally overlying the holes 118 formed in first section 114 when first portion 96 is positioned about a seat stem or seat tube.

One or more fasteners 120 pass through holes 118 and engaged corresponding nuts 122 such that tightening of fasteners 120 and nuts 122 generates a clamping force between first section 114 and second section 116 of body 94. Alternatively, contour 112 could be constructed to snuggling and operationally engage a seat post or seat tube without the clamping force associated with an additional fastener. It is further appreciated that first section 114 extend further or even the full length of body 94 such that the respective sides of body are generally mirror images of one another. Although such a construction increases the total amount of carbon fiber material consumed by body 94, such a construction enhances the strength of second portion 98 of body 94 in doubling the lateral thickness of second portion 98. Second portion 98 of body 94 also includes a number of holes or perforations 124, 126, 128, 130, 132, 134 formed therethrough. Perforations 124, 126 are constructed to engage a fastener 136 that is constructed to secure connecting means 104, 106 to body 94. The slotted construction of perforations 124, 126 allows for translation of the respective connecting means 104, 106 relative to body 94 such that body 94 can be support accessories having a variety of constructions. Comparatively, perforations 128, 130 are constructed to allow passage of the elongated connecting means 108, 110, as shown in FIG. 1, therethrough.

As shown in FIG. 1, although connecting means 108, 110 are constructed to removably attach water bottle 102 to body 94, as shown in FIG. 2, perforations 132 are generally constructed to engage what is commonly referred to as a water bottle cage, or a wire form assembly configured to support a water bottle. Additionally, opening 134 of body 94 could be constructed to generally correspond to a mating structure of any desired accessory such that the accessory would directly engage body 94 without any intervening connecting means or fasteners. Additionally, it is further appreciated that body 94 include cavities, such as opening 135 that are constructed to reduce the carbon fiber material consumed by formation of body 94 without detrimentally affecting the strength or performance of accessory mounting bracket 94 or accessory mounting system 12.

During operation of bicycle 10, in airflow, indicated by arrow 138, generated by forward movement of bicycle 10 fools relatively smoothly over opposing sides 140, 142 of body 94 thereby providing a generally aerodynamic accessory supporting bracket. The generally planer orientation of body 94 reduces the aerodynamic impact a rider's performance attributable to the accessory mounting system 12. Furthermore, the carbon fiber construction of body 94 provides an accessories supporting system that is generally robust and can withstand the rigors associated with bicycle operation.

Therefore, one embodiment of the invention includes a bicycle accessory mounting bracket having a body formed of a carbon fiber material. A first portion of the body is constructed to secure the body to a seat post of a bicycle. A second portion of the body extends from the first portion and is constructed to connect an accessory to the body.

A bicycle accessory mounting system according to another embodiment of the invention includes a carbon fiber bracket that has a first part and a second part. The first part has a contour that substantially matches a contour of a bicycle seat post. The second part has a generally planar contour and is constructed to extend rearward of the bicycle seat post from the first part. The mounting system includes means for connecting an accessory to the second part of the bracket.

A method of forming an accessory mounting bracket according to a further embodiment of the invention includes forming a body from a carbon fiber material. A passage is formed with the body and configured to receive a portion of a bicycle frame.

The present invention has been described in terms of the preferred embodiment, and it is recognized that equivalents, alternatives, and modifications, aside from those expressly stated, are possible and within the scope of the appending claims.

What is claimed is:

1. A bicycle accessory mounting bracket comprising:
a body formed of a carbon fiber material;
a first portion of the body constructed to secure the body to a seat post of a bicycle; and
a second portion extending from the first portion and constructed to connect an accessory to the body.

2. The mounting bracket of claim 1 further comprising a number of openings formed in the second portion for engaging at least one of a threaded fastener, a hook and loop fastener, and a water bottle cage.

3. The mounting bracket of claim 1 wherein the first portion is contoured to generally enclose a cross-section of the seat post.

4. The mounting bracket of claim 1 wherein the second portion includes a first section and a second section that extend from generally opposite sides of the first portion, each of the first section and the second section having a generally similar shape.

5. The mounting bracket of claim 4 wherein the first section and the second section are constructed to extend rearwardly from the first portion and are constructed such that a side wall of each of the first section and the second section engage each other when the mounting bracket is secured to a bicycle.

6. The mounting bracket of claim 1 wherein the first portion and the second portion each have a contour constructed to cooperatively provide aerodynamic contour.

7. A bicycle accessory mounting system comprising:
a carbon fiber bracket having a first part and a second part, the first part having a contour that substantially matches a contour of a bicycle seat post;
the second part having a generally planar contour and constructed to extend rearward of the bicycle seat post from the first part; and
means for connecting an accessory to the second part of the bracket.

8. The mounting system of claim 7 wherein the connecting means is at least one of a threaded fastener, a snap, a strap, a contour, and a hook and loop fastener.

9. The mounting system of claim 7 wherein the accessory is a water bottle cage secured to the carbon fiber bracket by the connecting means and constructed to engage a water bottle.

10. The mounting system of claim 7 wherein the accessory is at least one of a water bottle, a tire, a gas source, and a pump.

11. The mounting system of claim 10 wherein the gas source is a CO₂ container constructed to fill a bicycle tire.

12. The mounting system of claim 7 wherein the second part includes a first portion and a second portion wherein each portion extends from the first portion in a common direction from the bicycle seat post.

13. The mounting system of claim 12 wherein the first and second portions have generally similar shapes.

14. The mounting system of claim 13 further comprising a plurality of openings formed in each of the first and second portion, each opening formed in the first portion constructed to be generally aligned with an associated opening formed in the second portion.

15. A method of forming an accessory mounting bracket comprising the steps of:
forming a body from a carbon fiber material; and
forming a passage to receive a portion of a bicycle frame with the body.

16. The method of claim 15 further comprising forming the passage at an end of the mounting bracket.

17. The method of claim 15 wherein the passage is formed by wrapping a portion of the body back toward itself.

18. The method of claim 15 further comprising forming the passage at a middle portion of the body.

19. The method of claim 15 further comprising orienting the passage relative to the body such that an axis of the passage is generally is generally aligned with an elongated plane of the body.

20. The method of claim 15 further comprising forming a plurality of openings in the body remote from the passage for securing cycling accessories to the body.

21. The method of claim 20 wherein the accessory is at least one of a cage for engaging a water bottle, a water bottle, a tire, a gas source, a pump, a tool, and a multi-function tool.

22. The method of claim 20 wherein the portion of the bicycle frame is further defined as a seat post.
